(19) United States
(12) Patent Application Publication
(10) Pub. No.: US 2021/0209081 A1
(43) Pub. Date: Jul. 8, 2021

(54) MEDIUM FOR REVISION

(71) Applicant: HOLDHAM, Hérouville-Saint-Clair (FR)

(72) Inventor: Éric JOAN, Saint Contest (FR)

(21) Appl. No.: 17/143,424

(22) Filed: Jan. 7, 2021

(30) Foreign Application Priority Data
Jan. 7, 2020 (FR) 20 00 101

(51) Int. Cl. G06F 16/22

(52) U.S. Cl. CPC G06F 16/2228

(57) ABSTRACT

A method for indexing handwritten information includes a step where a user is provided with a collection of stationery products, where each carries a colour and a machine-readable code that is uniquely associated with the colour. The method further includes steps where handwritten notes are taken by the user, each on a different product in the collection selected by the user based on the colour carried by product. Photographs of the products showing the notes are taken with a sensor incorporated in a mobile terminal. The method also includes steps for decoding machine-readable codes by the mobile terminal so as to allow the determination of their respective values and storage of the photographs in a memory by the terminal, with the indexing of images depending on the value of the code.

### CROSS-REFERENCE TO RELATED APPLICATIONS

This application is related to and claims the benefit of French Patent Application No. 20 00 101, filed on Jan. 7, 2020, the contents of which are herein incorporated by reference in their entirety.

### TECHNICAL FIELD

This disclosure relates to a range of cards classified by sets of 80 cards for example. The range may for instance comprise 12 different colours. The cards in one set may all be of the same colour or of different colours. By putting together several sets, it is in any case possible to have cards in all the colours of the range. Each colour defines a category or subject.

### BACKGROUND

School and college students need to revise for their examinations. Other categories of people also need to take examinations in the course of their working life or if they take up studies once again, and to prepare for them by revising different subjects.

### DESCRIPTION OF THE DISCLOSURE

The range of cards may for instance be made of white cardstock, with a coloured edge on one side to show the category. The side may be ruled. That side is the useful side, on which the user enters handwritten information for the purpose of their revisions, using a pen, felt-tip pen or pencil. The other side may also be used for taking notes. Identical ruling may be present on the two sides, but it may also be that neither side is ruled, or with different ruling, or that only one of them has ruling.

On the mentioned side, the cards have corner markers that can be identified easily by software analysing a photograph of the useful side of the card, taken on the fly, using a smartphone, for example. The software may be executed by the processor of the smartphone. The smartphone may be replaced by an computer tablet. The software that identifies the four corners with the corner markers can rectify the image and produce a rectified image as would be obtained using a flatbed scanner, even though the photograph has been taken on the fly, without no careful or controlled selection of the solid angle from which it has been taken.

The software makes it possible to classify, merge, name and electronically annotate the images of cards that have first been annotated by hand in the initial note-taking operation.

If the software is executed by a terminal such as a smartphone, a computer or a tablet connected to the Internet, the images can be saved in the cloud.

As a result, the user can use their revisions solution at any time, very easily, with no physical constraint.

By convention, the colour of the card, out of 12 different colours for example, corresponds to a given revision subject (or school subject to revise). The user's eye easily recognises the colours and tells them apart, even if the lighting is of mediocre quality, as you only need to move the card to see different views of it.

For its part, the software has only a fixed single view of the card, and differentiates the card colours on the basis of a code that is printed on the card in a legible and rugged manner by a machine independently from the conditions in which the photograph is taken. Thus, even with low light or the use of a digital image sensor of mediocre quality, the card category is recognised by reading the machine-readable printed code. Each code value that can be read robustly by a machine corresponds to one and only one colour, that is to say one and only one category.

The disclosure thus comprises a method for indexing handwritten information including a step where a user is provided with a collection of stationery products or items, where each carries a colour and a machine-readable code that is uniquely associated with the colour, steps where handwritten notes are taken by said user, each on a different product in the collection selected by the user based on the colour carried by said product, photographs of the products showing the notes are taken with a sensor incorporated in a mobile device, such as a mobile terminal, steps for decoding machine-readable codes, for example by the mobile terminal, so as to allow the determination of their respective values and storage of the photographs in a memory, for example by the terminal, with the indexing of said images depending on the value of the code.

1. A method for indexing handwritten information, the method including the following steps: providing a user with a collection of stationery products, where each carries a colour and a machine-readable code that is uniquely associated with the colour, taking handwritten notes by said user, each on a different product in the collection selected by the user based on the colour carried by said product, photographs of the products showing the notes which are taken with a sensor incorporated in a mobile device, and decoding machine-readable codes to allow the determination of their respective values and storage of the photographs in a memory with the indexing of said images depending on the value of the code.
